(19) United States
(12) Patent Application Publication
(10) Pub. No.: US 2006/0094466 A1
(43) Pub. Date: May 4, 2006

(54) Systems and methods for providing expansion to wireless communicators

(76) Inventor: Bao Tran, San Jose, CA (US)

Correspondence Address: TRAN & ASSOCIATES, 6768 MEADOW VISTA CT., SAN JOSE, CA, 95135, US

(21) Appl. No.: 10/970,548

(22) Filed: Oct. 20, 2004

(51) Int. Cl. H04B 1/38

(52) U.S. Cl. 455/558; 455/41.2

(57) ABSTRACT

An add-on circuit for expanding the functionality of a wireless telephone includes an expansion board adapted to be plugged into an expansion port of the wireless telephone; an expansion circuit mounted on the expansion board; and computer code executed by the wireless telephone to retrieve information from the expansion circuit and communicate the information to a user.

### BACKGROUND

The present invention relates to add-on cards that expand the capabilities of communicators such as cellular phones.

There are a variety of standards for integrated circuit (IC) cards, which can be mounted on mobile devices such as notebook personal computers (PC), personal digital assistants (PDA), digital video devices, digital cameras, and portable audio devices. These mobile devices will be referred to collectively as “host devices”. Recently, SD memory cards have been attracting attention because of their small size, high data transfer rates, and enhanced security features. For the purposes of this disclosure, the abbreviation “SD” stands for “secure digital” and various devices and their components related to this secure digital technology may be identified by the abbreviation “SD.”

The SD cards are attracting attention as portable media like floppy disks (FD). The SD card has a larger capacity per unit size, so that they useful for recording and reproducing image data or audio data If the access to the SD card is restricted to a read-access, a basic input/output system (BIOS) is not required. In addition, only required data can be read out according to the access from a central processing unit (CPU), and therefore, a program can be executed on the SD card without data copying to a random access memory (RAM). If a communication error occurs, a communication speed is automatically reduced step by step to a speed at which no error occurs, and the processing is continued. Thus, it is possible to perform data communications without changing software and hardware.

As discussed in US Application Serial No. 2004/0205268, the international standards for SD-related devices include 1) the SD memory standard for memory devices, and (2) the SDIO standard for input/output devices (I/O). The SDIO standard is an extension of the SD memory card standard and covers input/output functions as well as memory functions. Card-shaped peripherals compliant with the SDIO standard are referred to as “SDIO cards.” An SDIO controller implements functions needed for peripherals to comply with the SDIO standard and connect to the host devices. An “SDIO wireless communication card,” which contains the SDIO controller equipped with a Universal Asynchronous Receiver Transmitter (UART) interface and wireless communication capabilities compliant with Bluetooth, is known as a conventional technology for SD-related devices. The SDIO wireless communication card is capable of communicating data from a host device, wirelessly via SDIO, to distant Bluetooth-compatible wireless communication devices.

### SUMMARY

An add-on circuit for expanding the functionality of a wireless communicator includes an expansion board adapted to be plugged into an expansion port of the wireless communicator; an expansion circuit mounted on the expansion board; and computer code executed by the wireless communicator to retrieve information from the expansion circuit and communicate the information to a user.

Implementations of the expansion circuit can be one of: an 802.11 transceiver, a Zigbee transceiver, a global positioning system receiver, a compass, a data storage device to store map data and to display the output of the expansion circuit with the map data, an altimeter, a barometer, a chronograph, a thermometer, a medical diagnostic unit, a television receiver, a radio receiver, a graphics accelerator, a connector to receive a game cartridge, a biometric detector, a bar code reader, a radio frequency identification (RFID) unit, a wireless credit card, a reserve energy supply, a super-capacitor, a solar cell, a fuel cell, a battery, and a PC compatible processor running Windows OS, Linux OS, or Macintosh OS X.

Advantages of the system may include one or more of the following. The system leverages the low cost of cell phones for additional functions such as viewing TVs and radios or playing games. Moreover, the upgraded or expanded phone provides value-added functions while the user is on-the-road. Thus productivity can be improved while the user experience with the cell phone is enhanced.

### BRIEF DESCRIPTION OF THE DRAWINGS

FIG. 1 shows an exemplary diagram of a cellular telephone with an add-on card.

### DESCRIPTION

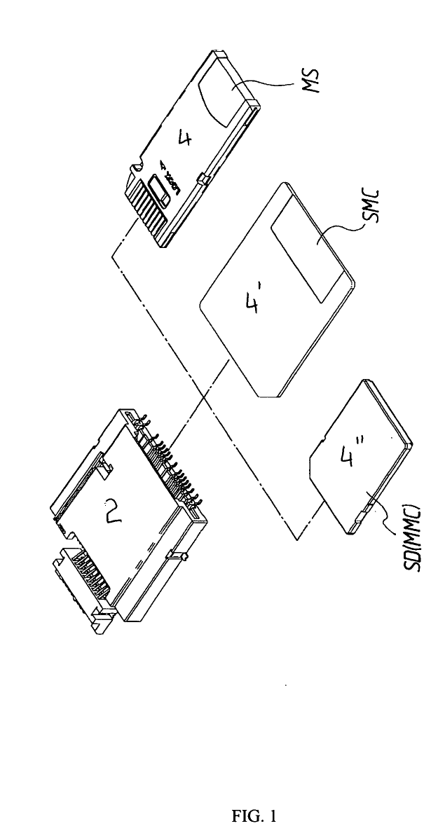

FIG. 1 shows an exemplary diagram of a cellular telephone connector 2 with an add-on card 4 (such as SD card) that can be inserted into an expansion slot. The telephone includes a processor; a display; an expansion port having an interface that can receive an expansion circuit on the add-on card 4. The cell phone may conform to any one of global system for mobile communications (GSM) services (or enhancements such as EDGE and GPRS), code-division multiple access (CDMA), time-division multiple access (TDMA), frequency division multiple access (FDMA), advanced mobile phone service (AMPS), and digital advanced mobile phone service (D-AMPS).

The add-on card 4 is adapted to be inserted in the phone 4 and has an expansion circuit therein. The expansion circuit can be at least one of: an 802.11 transceiver, a Zigbee transceiver, a global positioning system receiver, a compass, a data storage device to store map data and to display the output of the expansion circuit with the map data, an altimeter, a barometer, a chronograph, a thermometer, a medical diagnostic unit, a television receiver, a radio receiver, a graphics accelerator, a connector to receive a game cartridge, a biometric detector, a bar code reader, a radio frequency identification (RFID) unit, a wireless credit card, a reserve energy supply, a super-capacitor, a solar cell, a fuel cell, a battery, and a PC compatible processor running Windows OS, Linux OS, or Macintosh OS X.

During operation, a user may wish to expand the cellular telephone functionality or otherwise enhances the features available on the phone. This can be done by inserting a secure digital card with an expansion circuit into the cellular telephone. The expansion circuit can provide an 802.11 transceiver, a Zigbee transceiver, a global positioning system receiver, a compass, a data storage device to store map data and to display the output of the expansion circuit with the map data, an altimeter, a barometer, a chronograph, a thermometer, a medical diagnostic unit, a television receiver, a radio receiver, a graphics accelerator, a connector to receive a game cartridge, a biometric detector, a bar code reader, a radio frequency identification (RFID) unit, a wireless credit card, a reserve energy supply, a super-capacitor, a solar cell, a fuel cell, a battery, and a PC compatible processor running Windows OS, Linux OS, or Macintosh OS X. In one embodiment, a single function card provides one function, and in another embodiment, a multi-function card provides a plurality of the above circuits on a single card. Next, computer code is executed by the wireless communicator or cell phone to retrieve information from the expansion circuit and communicating the information to a user.

Each card has an SDIO controller positioned between circuits on the cellular phone 2 and circuit on the expansion card. The SDIO controller has an SD interface with control register(s) which deciphers commands received from an SDIO host device, and returns a necessary response to the SDIO host; a temporary buffer memory; and one or more application interfaces. In addition, the circuit can include a FIFO controller (i.e., DMA controller), a microcontroller unit, DRAM and flash memory, and general peripheral I/O or GPIO.

In one embodiment, the expansion circuit includes one or more of: an 802.11 transceiver, a Bluetooth transceiver, and a Zigbee transceiver. This card provides a wireless communication card that can be inserted in SDIO slots of SDIO host cellular phone. Preferably, an IEEE802.x, or other standardized wireless communication module, is used. For example, the expansion circuit can utilize one or both of IEEE standards 802.11a, 802.11b, 802.11g and 802.11n. The circuit includes a medium access controller (MAC) and a base band processor and a RF controller. Exemplary 802.11 ICs from Broadcom or Atheros can be used.

The present invention can also use a Bluetooth module as the wireless communications module in an SDIO wireless LAN communication device. In such a case, a Bluetooth module is connected to the SDIO controller in accordance with the present invention via a HS-UART interface, which is a standard Bluetooth port. Since the SDIO controller in accordance with the present invention can advantageously use existing application modules as SD applications, those skilled in the art would appreciate that the present invention can minimize the labor effort and other costs of design and development when applying SDIO technology to various host devices. Similarly, Zigbee modules can be used as an SDIO wireless LAN communication device.

Voice over Internet telephony (VoIP) code can be used to provide an alternate communication capability in addition to the cellular channels. In one embodiment, when a user dials a phone number on the cell phone, software on the system detects the availability of a wireless LAN such as an 802.11 network or a Bluetooth network. If the wireless LAN is available, the system attempts to call the number using VoIP based on the signal strength. To illustrate, in a system with both Bluetooth and 802.11, the system selects the LAN with the strongest reception. If the VoIP call on the first LAN fails, the system tries the second LAN. If all wireless LAN fails, the system would try the GSM phone last since the VoIP calls are virtually free and less expensive than cell phone charges. In another example, a system with GSM circuit and 802.11/Bluetooth circuits built-in the telephone 2 and an expansion card with Zigbee circuit can have four tiers of voice connection: 802.11, Bluetooth, Zigbee, and GSM in that order since 802.11, Bluetooth and Zigbee connections are cheaper than GSM connection and since 802.11 is faster than Bluetooth and Bluetooth is faster than Zigbee protocol, respectively.

The expansion circuit can include various applications such as a global positioning system (GPS) component, a digital compass component, or a personal handyphone system (PHS) component. As is well known, GPS is a collection of 24 NAVSTAR satellites owned by the US Government which orbit 12,000 miles above the earth and constantly transmit their individual positions as well as the current precise time-of-day. The current precise time-of-day is provided by one of four highly accurate on-board atomic clocks. Other similar systems can also be used in alternate embodiments of the present invention. One example of a similar system is the Russian GLONASS system. In general, the GPS and other similar systems provide highly accurate positioning and navigational information. GPS receivers listen to the information received from at least three satellites to determine the precise location of the receiver, as well as velocity and bearing information (if in motion). The GPS receiver determines its distance from the satellite by using the travel time of the radio message from the satellite to the receiver. After calculating its relative position from at least three satellites, the current position is calculated using triangulation techniques. In one GPS embodiment, Seiko Epson's S4E19863 GPS is a single chip with a wideband GPS-processor, a receiving radio frequency GPS-tract and a peripheral stud. The working voltage varies from 1.5-1.8 v, besides the module can be fed by voltage sources 1.8 v or 3.3 v. The device's TTFX (Time to First Fix) is 2-3 s outdoor and 7 s indoor.

Optionally, a data storage device can be provided on the expansion card to store a map database, wherein map or GIS code displays the output of the GPS expansion circuit with the map data. The map database can have various levels of detail and include geographical information at the major road level. Additional details that can be included are minor roads, turn restrictions, one-way streets, highway ramp configurations, hotel, restaurant and other business information, traffic history, emergency facility locations and the like. The map database with routing information is referred to as navigable map data or turn-by-turn data. Alternatively, the client navigation system establishes a wireless connection to a navigation server on a computer network as discussed in U.S. Pat. No. 6,292,743, the content of which is incorporated by reference. The client requests a route by uploading start and stop specifications. The server calculates an optimal route based on real-time data available on the network. A generic natural language description is used to specify the optimal route downloaded to the client. The natural language description is independent from the local mapping database software on the client and includes a plain text description for each link using pre-defined generic terms. The client interprets the route, interfaces with the local mapping database and reconstructs the optimal route using a mapping reconstruction algorithm. The route is displayed on the client navigation system using whatever mapping database is present. An enhanced user-interface data-entry feature is provided that anticipates data being entered by users to minimize the data-entry process. The current time zone is derived from the current GPS position and is used to set the clock on the navigation system in the client. Maps are automatically scrolled on a display screen so that a representation of the automobile is always pointing to the right or to the left to allow for additional look-ahead space on certain display systems. A telephone coupled with the navigation system automatically displays the current local time for a called party upon dialing out. The dialed number is used to query a local database for providing local time information.

The expansion circuit can include at least one of an altimeter, a barometer, a chronograph, and a thermometer. In one embodiment, a Motorola absolute pressure sensor MPXS 4100A with suitable low pass filters are used, and the output is digitized by a DAC and the output is captured by a microcontroller. For accuracy, temperature and non-linear pressure-altitude correction algorithms are then applied. The barometer can use the same pressure sensor, or a second high-precision air pressure transducer can be used display absolute pressure, altitude, and corrected barometric pressure. The chronograph is implemented in software as a precision timer. A temperature sensor is used as a thermometer, and the output of the thermometer can be used to provide corrective feedback to the altimeter and the barometer.

The expansion circuit can also be a circuit that receives one of television signal and radio signal. In one embodiment, a miniature, digitally tuned radio IC such as the Philips TEA5767/68 requires zero external alignments, resulting in shorter design times and lower manufacturing costs due to simplified component placement and reduced logistics overhead. The radio is capable of tuning to European, US and Japanese FM bands. In other embodiments, short wave and long wave bands can be received as well.

In another embodiment, a single chip television chip such as the Sanyo LA76810 Single-Chip Color TV IC Series can be used to capture analog TV signals and the decoded signals are rendered on the cellular telephone's display for viewing. Alternatively, one-chip TV solutions that are integrated with a stereo decoder and an audio digital signal prqcessor can be used to display analog TV channels. For example, Philips' One Chip Third Generation device, the UOCIII, contains the complete functionality of a television set, including a TV signal processor, a teletext/closed-caption decoder, graphics generator, a microcontroller core with an extended 80C51 instruction set and newly integrated stereo functionalities. Other TV ICs from Toshiba, Mitsubishi, Sanyo and Micronas can be used.

In yet another TV embodiment, HDTV channels are received locally at each base station and down-sampled for cell phone resolution viewing. The down-sampled streaming videos are stored in a video server that in turn broadcasts the images over a high speed wireless link. The HD channels are then streamed or transmitted over the high speed wireless link such as 802.11 to the user's cell phone and decoded and rendered for viewing. Alternatively, the channels can be transmitted over EDGE or GPRS cellular channels for decoding and viewing by the user. In one embodiment, the screen of the cellular telephone conforms to the standard 4 by 3 aspect ratio, which means the screen is 4 units wide by 3 units high. But theatrically released movies are usually in a much wider aspect, taking advantage of the human field of vision (which is wider across horizontally). Thus, in another embodiment, the cellular phone's display conforms to the HDTV 16 by 9 aspect ratio and provides the wide-scope of movies. This embodiment's 16 by 9 aspect ratio makes for a more immersive and intense viewing experience on the cell phone.

The expansion circuit can also be a graphics accelerator. In one embodiment, the accelerator can be Nvidia's GoForce 2150 which includes a 64-bit 2-D graphics controller and supports more than 70 different display interfaces, including TFT, LCD, and OLED screens with a resolution of up to 320 pixels by 480 pixels. The chip's LCD controller allows fast-switching between dual screen interfaces, such as those found on clam-shell phone handsets with a small external display and a larger internal color screen. The GoForce 2150 supports digital cameras with a resolution up to 1.3 megapixels and can support JPEG video capture.

For advanced gaming applications, the expansion circuit can provide a connector coupled to the expansion board and adapted to receive a game cartridge such as Nintendo's Game-Boy cartridge. In another embodiment, the content of the cartridge ROM is copied to a data storage device on the card 4 and thus, the connector is not needed. In either case, a game operating system emulator code is executed in the cell phone processor to enable the phone to act as a GameBoy console to play game code stored in the game cartridge. In one embodiment, the system runs Snes9x, a portable, freeware Super Nintendo Entertainment System (SNES) emulator that allows the user to play most games designed for the SNES and Super Famicom Nintendo game systems. Snes9x environment available at www.snes9x.com is coded in C++, with three assembler CPU emulation cores.

The expansion circuit can also be a biometric detector such as finger print scanners and retinal scanner as known in the art. The finger print scanner detect features are available for biometric identification: Coarse features (loops, arch, whorls, . . . ); Fine features (minutia); and Pore structure. Coarse features have strong genotypic contributions and are suited for presorting during an identification with a very large data base. The minutia are predominantly randotypic in nature and cause most of the uniqueness in a fingerprint. Therefore, either directly or indirectly (in picture correlation procedures), almost all fingerprint systems examine minutia. Pore structure is seldom used, due to large fluctuations in the quality of the scanning procedure. Various fingerprint sensors can be used, including Static capacitive Type 1; Static capacitive Type 2; Dynamic capacitive; Luminescent capacitive; Optic reflexive; Optic transmissive with fiber optic plate; Acoustic (ultrasound); Pressure sensitive; Thermal line; and Capacitive and optical line.

In another embodiment, a single dual-axis pivoting micromirror can be used to perform retinal scanning as well as displaying images to users. The Retinal-Scanning Display Electronic creates SVGA-resolution images by rapidly scanning a single pixel directly on the back of the eye. Since the scanning motion is continuous, the device produces an image that is effectively unpixelated, making it suitable as a viewfinder in high-resolution digital cameras. For example, Microvision (Bothell, Wash.) device's color gamut (with a 16-bit color depth) and control are superior to that of LCD imagers because the device uses individual RGB edge-emitting LEDs as the light source.

Additionally, face recognition software can process facial images captured by the cell phone's camera and used to unlock the operation of the phone. In one embodiment, a three-dimensional face-identification system which incorporates facial fiducial values (points) is used. These fiducial values are used to index a facial image determining the composite code for the image. The composite code is used to regenerate the facial image from a group of standard facial feature parts. A photograph captured by the cell phone camera is analyzed to determine its facial fiducial values corresponding to a three-dimensional (3-D) model of the face. Once these facial fiducial values are obtained with respect to a three-dimensional model, they are used to determine the proper composite codes for the 3-D facial image. These composite codes correspond to a facial feature parts database. More information for this technique is discussed in U.S. Pat. No. 6,801,641, the content of which is incorporated by reference.

The expansion circuit can also receive medical diagnostic data. For example, the device can capture a patient's vital parameters. The patient may wear one or more sensors, for example devices for sensing ECG, EKG, blood pressure, sugar level, among others, that communicate with the cell phone using Zigbee wireless transceivers. In one embodiment, the sensors are mounted on the patient's wrist (such as a wristwatch sensor) and other convenient anatomical locations. Exemplary sensors include standard medical diagnostics for detecting the body's electrical signals emanating from muscles (EMG and EOG) and brain (EEG) and cardiovascular system (ECG). Leg sensors can include piezoelectric accelerometers designed to give qualitative assessment of limb movement. Additionally, thoracic and abdominal bands used to measure expansion and contraction of the thorax and abdomen respectively. A small sensor can be mounted on the subject's finger in order to detect blood-oxygen levels and pulse rate. Additionally, a microphone can be attached to throat and used in sleep diagnostic recordings for detecting breathing and other noise. One or more position sensors can be used for detecting orientation of body (lying on left side, right side or back) during sleep diagnostic recordings. In one embodiment, the sensor for monitoring vital signs is enclosed in a wrist-watch sized case supported on a wrist band. The sensors can be attached to the back of the case. For example, in one embodiment, Cygnus' AutoSensor (Redwood City, Calif.) is used as a glucose sensor. A low electric current pulls glucose through the skin. Glucose is accumulated in two gel collection discs in the AutoSensor. The AutoSensor measures the glucose and a reading is displayed by the watch. In another embodiment, EKG/ECG contact points are positioned on the back of the wrist-watch case. In yet another embodiment that provides continuous, beat-to-beat wrist arterial pulse rate measurements, a pressure sensor is housed in a casing with a ‘free-floating’ plunger as the sensor applanates the radial artery. A strap provides a constant force for effective applanation and ensuring the position of the sensor housing to remain constant after any wrist movements. The change in the electrical signals due to change in pressure is detected as a result of the piezoresistive nature of the sensor are then analyzed to arrive at various arterial pressure, systolic pressure, diastolic pressure, time indices, and other blood pressure parameters.

The cell phone can also become a garage opener with a suitable add-on expansion card. The garage opener sends RF signals or other electromagnetic signals having particular signal characteristics which, when received, cause the door to be opened. One embodiment provides radio transmitters which employ coded transmissions of multiple or three-valued digits, also known as “trinary bits” or other serial coded transmission techniques. In another embodiment, a transmitter and receiver combination is provided in the garage opener expansion card wherein the transmitter stores an authorization code which is to be transmitted to and received by the receiver via a radio frequency link. In order to alter or update the authorization code contained within the transmitter, the receiver is equipped with a programming signal transmitter or light emitting diode which can send a digitized optical signal back to the transmitter where it is stored.

The expansion circuit can be a radio frequency identification (RFID) unit. The RFID can be a reader or an ID transmitter. In the reader configuration, the RFID reader can retrieve inventory data and communicate the information to the cell phone for tabulating inventory counts, for example. In the embodiment where an RFID transmitter is on the expansion card, the cell phone serves as an ID for the user. The ID can be used to control access into buildings, or alternatively, can be used to credit/debit value for the person.

In one embodiment, the expansion circuit contains one or more radio frequency identification (RFID) tags. The RF tag is an integrated circuit that is coupled with a mini-antenna to transmit data. The circuit contains memory that stores the identification Code and other pertinent data to be transmitted when the chip is activated or interrogated using radio energy from a reader. In one embodiment, capacitively coupled RFID tags are used. The capacitive RFID tag includes a silicon microprocessor that can store 96 bits of information. A conductive carbon ink acts as the tag's antenna and is applied to a paper substrate through conventional printing means.

In another embodiment where the cell phone collects RFID data, a reader is positioned on the cell phone expansion card and consists of an RF antenna, transceiver and a micro-processor. The transceiver sends activation signals to and receives identification data from the tag. The antenna may be enclosed with the reader or located outside the reader as a separate piece. RFID readers communicate directly with the RFID tags and send encrypted usage data over a network to a server to tabulate statistics.

In a non-RF embodiment, the expansion circuit can be a laser bar code reader. Alternatively, the bar code can be captured using the camera on the cell phone and bar code pattern recognition is applied to convert the pattern into data.

The expansion circuit can also be a security device that turns the cellular phone into a wireless credit card. The RFID data can be transmitted to a credit card computer in a contactless manner. In addition to RFID data, extra security can be tested such as verifying the unique cell phone ID (IMEI) and a security code such as SP lock code from the phone's IMEI. Additionally, biometric scanning as described above can be used to authenticate the credit card user to the credit card merchant. Upon verification, a credit card number can be provided to the credit card merchant computer upon query. The result of the transaction can be captured for subsequent verification of transactions for the credit card user.

In another embodiment, the expansion circuit provides extra energy. This can be any suitable reserve energy supply such as a super-capacitor, a solar cell, a fuel cell, and a battery mounted on the expansion card and inserted into the cell phone as needed. The solar cell can also extend from the expansion card and charge a reserve battery mounted on the expansion card.

In another embodiment, the expansion circuit is a smart card or smart card that allows the digital data to be decrypted on any device that supports the smart card or chip, and the use of public and private keys in conjunction of a portable smart card or smart card to access controlled content by tying the encrypted data to the smart card or smart card that can be used with any cell phone device that supports the smart card or chip. One exemplary public key/private key based encryption/decryption system that may be used in the subject invention is the well-known Rivest-Shamir-Adelman (RSA) system. An example of Software employing this system is commercially available as Pretty-Good Privacy (PGP).

In another embodiment, the add-on circuit enables the cell phone to implement loyalty programs by a loyalty operator and eliminates the need to have custom prearranged file structure definitions between a loyalty operator and each card issuer. A loyalty operator no longer needs to negotiate an agreement with each and every single issuer in order to have the issuer's card accepted in the loyalty program of the operator, i.e., a smart card need not be custom made for each loyalty program. In one embodiment, any number of loyalty files with standard header information and variables are implemented in a memory of the cell-phone expansion card. The structure of a loyalty file and the basic commands used to interface with the loyalty file are known beforehand by acquiring banks, and by loyalty operators that are developing loyalty application software. When a customer uses a loyalty card in conjunction with a merchant, the merchant terminal determines whether a loyalty file is available for use. If so, the terminal is able to go on-line in real time to communicate with the issuer to receive a password to allow access to the selected loyalty file and other identifying information. In this fashion, the issuer can keep control over the use of particular loyalty files on cell phones and keep track of which loyalty operators have enrolled which customers in loyalty programs. The loyalty file on the smart card is made available for use by the loyalty application software of the loyalty operator and in exchange, the loyalty operator makes a payment to the issuer. From this point on, the loyalty operator makes use of its own loyalty application software to read from and/or write to the loyalty file on the cell phone any data it desires. A loyalty operator is able to enroll a customer in their loyalty program regardless of the bank from which the card was issued. Loyalty operators can define their own loyalty application software and determine their own level of security needed, without having to predefine a security level before the card is issued. A loyalty operator is also allowed access to a loyalty file on a smart card in real time, thus permitting a customer to be enrolled and data to be transferred to or from the card while the customer is waiting. A loyalty operator can also choose their own password for access to a file and can decide their own level of security needed for a particular file. Furthermore, no key exchange is required between the parties. In another embodiment, the expansion card provides Electronic Travellers Cheque (ETC) function. The process can also be used for money transfer and any other pre-paid cash access product. A file is issued to a customer with a value selected by the customer. Unlike a credit or debit card, the value is fixed. Unlike a transit card, the amount of the value of the card is stored in a central computer. The card can be used to access the account through an ATM or other terminals world-wide, with the use of a personal identification number (PIN) to provide added security greater than that, for instance, given by the signature on a traditional paper travellers cheque. The card is disposable when the account is depleted, with a new file and account required for a new amount of cash. The file contains an encoded card number including a bank identification number (BIN) and an account number. The cards may be issued by multiple ETC issuers who have financial responsibility for the accounts, but are processed on their behalf by a single entity referred to as the ETC processor herein. The ETC processor establishes a zero balance database including the card numbers, but with blank fields for the customer data (name, address, etc.) and the value of the card. The cards are provided to a bank or other sales agent. When a customer purchases a card, the sales agent uses local software to remotely transmit to the central database the card number (or a serial number) along with the customer data and the amount purchased. The software at the ETC processor fills in the blanks in the database, activating the account, and transmits an acknowledgement signal back to the sales agent software.

The customer can immediately use the cell phone with the ETC in ATM or other remote terminals to acquire cash or purchase goods or services. The customer inputs a PIN number which is provided with the card, or a customer selected alternative PIN number. The transaction is handled by the ATM or other terminal in much the same manner as a normal ATM transaction using an ATM card.

The BIN number of the issuing institution is stored in the database in the ETC processor along with an indication of the currency used for issuance. A particular bank may have multiple BIN numbers for multiple types of currencies in which cards can be issued. When a customer uses the card in a remote terminal, that terminal may be connected to an intermediate network, such as the VisaNet network. The currency of the terminal is transmitted to the central VisaNet computer, and the central VisaNet computer does a currency conversion, if necessary, to debit the account balance.

The serial number provides an additional level of security. The sales agent can transmit the serial number, making it more difficult for someone to intercept the message and determine the account number. Also, a customer can select or change the PIN from any touch tone phone by using the serial number printed on the card. In addition, the central database has fields for storing status information indicating that certain serial number cards have been ordered from the manufacturer, shipped to the sales agent, and received by the sales agent. This information can be accessed by standard inventory software to track it and keep it current for security to insure an agent is authorized to sell a particular serial number card.

In operation, an issuing bank issues the file to a user with a predetermined value, e.g. $25 and the file is downloaded to the expansion card. The user may use that phone with the expansion card to complete a cashless transaction of a relatively small amount. For example, to purchase a soda the user will wirelessly pay using the cell phone with the expansion card at the sales/transaction terminal (i.e., soda machine) and the amount of the transaction will be deducted from the balance on the file. If the balance on the file is less than the transaction amount, the balance will automatically be renewed by the terminal, that is increased by a predetermined amount. In this manner, if the user has only a $1.00 balance remaining on the file and the transaction amount is $1.50, the user's file will be increased a set amount, e.g. $25.00. The new net balance will be $24.50, taking into account the amount previously remaining on the file and the transaction amount.

In another embodiment, a data storage device is mounted on the expansion circuit card. The system can automatically synchronize data stored on the storage device with remotely located data. In one method, a first file transfer program is executed by a remote processor such as a PC that manages file transfers from the data storage unit. A file transfer program on the processor communicates across the wireless communication link (Bluetooth or 802.11) to a PC file transfer program that runs on the personal computer system 150. The PC file transfer program communicates with a PC file system (such as Microsoft Windows) on the personal computer system. To invoke the file transfer system, a user executes the PC file transfer program on the personal computer system. Alternatively, the processor can detect the presence of a Bluetooth or 802.11 signal, for example, and automatically trigger the synchronization process. The data storage unit can store a user preference and the controller transmits the user preference to a remote unit for customizing the unit. The unit can be a computer and the user preference is used to customize the computer to the user. In one embodiment, the storage unit stores the user's favorite or frequently accessed URLs. Password information may be encrypted and stored in the storage unit for web sites that require login information.

In another embodiment, the data storage unit stores data to replicate a user's computer so that the user's computer states can be replicated at a remote location for the user. When the user travels to the remote location, the replicated data is used to reconstruct a computer that is identical to the computer whose states have been replicated and stored in the data storage unit. The replication of computer states can be done using various techniques known to those skilled in the art, for example as disclosed in U.S. Pat. No. 6,442,684 to Lee, et al. and entitled “Determining a current machine state of software”, the content of which is incorporated by reference. For example, data stored can describe a set of predetermined functionality for a computer system or for a user. The data may also include information on one or more operating system settings such as printer settings, font settings, network device settings, among others. Moreover, the data may also include information on files such as data files, initialization files, source files, and templates, among others. The data may include system state information on executable files such as .exe files, .dll files and .ocx files as well as machine state such as registry settings, environment variables, support files, and data files at particular points in time. The system also provides synchronization-database and target-database. The synchronization-database consists of items, each selecting one or more files the user wants to be synchronized and also other properties like a description and sync-method, for example. The sync-method can be directional by copying from the remote data storage device and overriding data on the data storage device 14 or vice versa, or can be time-based so that the latest version is retained in both data storage devices. The target-database holds data about all the computers (targets) that the user wants to be synchronized and for each target information on when the user last exported files and last imported files. Alternatively, the unit can be a vehicle and the customization can include car seat position adjustment, favorite radio channels, sound settings, and others. For room customization embodiment, the customization can include lighting level adjustment, room temperature adjustment, music volume, radio selection and television selection, among others.

The circuit card can include a field programmable gate array (FPGA) that provides on-the-fly circuits to optimize a particular operation. For example, the FPGA can be programmed to be a Java processor to accelerate Java processing. In one embodiment, the FPGA runs JOP (Java Optimized Processor), an open core available at www.jopdesign.com. JOP is a full-pipelined architecture with single cycle execution of microinstructions and mapping of Java bytecode to these microinstructions. Three stages form the core of JOP to execute microcode. A stage in front of the pipeline fetches Java bytecodes, the instructions of the JVM and translates these bytecodes to addresses in microcode. The second pipeline fetches JOP instructions from microcode memory and executes microcode branches. The third pipeline stage performs the decode function and address generation for the stack RAM.

In another embodiment, the expansion circuit can be a PC compatible processor with Windows OS, Linux OS, or Macintosh OS X. This embodiment allows software written for desktop computers to be run by the cell phone for particular mobile operation requirements. In one embodiment, pure software emulation creates a “virtual machine” that runs on the cell phone. This virtual machine is much like a real computer—the user can install an operating system on it, such as Windows XP, and the user can install programs, such as Microsoft Access or Visio—all it lacks is actual hardware. In a pure hardware embodiment, the processor's interrupt handling table and I/O map are modified so that the interrupt service routines and I/O accesses for I/O calls such as video, audio, keyboard and peripheral calls are rerouted to the cell phone peripherals, audio and video I/O devices. Software on the phone then displays the output and prompts the user for input as though the software was running on a regular personal computer. In a mixed hardware/software embodiment, an FPGA provides customizable hardware to accelerate the emulation of the processor to provide flexibility in running specific software that the cell phone would otherwise cannot process.

The system operates with any small size memory card, including Secure Digital (SD) card, SmartMedia (SM) card, Multimedia card (MMC), CompactFlash (CF) card, PC card, Memory Stick and xD Picture card, among others. The system also operates with cellular telephones as well as telephones that communicate over POTS land-line.

The invention has been described in terms of exemplary embodiments, it is contemplated, however that the invention include variations within the scope of the appended claims. For example, it is contemplated that the invention may be realized in a computer program existing on a carrier such as a magnetic or optical disk or a radio frequency or audio frequency carrier wave.

Many of the parts, components, materials and configurations may be modified or varied, which are not specifically described herein, may be used to effectively work the concept and working principles of this invention. They are not to be considered as departures from the invention and shall be considered as falling within the letter and scope of the following claims.

What is claimed is:

1. An add-on circuit for expanding the functionality of a wireless telephone, the add-on circuit comprising:
an expansion board adapted to be plugged into an expansion connector of the wireless telephone;
an expansion circuit mounted on the expansion board; and
computer code executed by the wireless telephone to retrieve information from the expansion circuit and communicate the information to a user.

2. The circuit of claim 1, wherein the wireless telephone comprises a GSM cellular telephone and wherein the expansion circuit comprises one or more of: an 802.11 transceiver, a Bluetooth transceiver, and a Zigbee transceiver.

3. The circuit of claim 2, wherein the code comprises voice over Internet telephony (VoIP) code.

4. The circuit of claim 1, wherein said expansion board comprises a secure digital (SD) card.

5. The circuit of claim 1, wherein the expansion circuit comprises at least one of a global positioning system receiver and a compass.

6. The circuit of claim 5, comprising a data storage device to store map data, wherein the code displays the output of the expansion circuit with the map data.

7. The circuit of claim 1, wherein the expansion circuit comprises at least one of an altimeter, a barometer, a chronograph, and a thermometer.

8. The circuit of claim 1, wherein the expansion circuit receives one of television signal and radio signal.

9. The circuit of claim 1, wherein the expansion circuit comprises a graphics accelerator.

10. The circuit of claim 1, wherein the expansion circuit comprises:
a connector coupled to the expansion board and adapted to receive a game cartridge; and
game operating system emulator code to enable the wireless communicator to play game code stored in the game cartridge.

11. The circuit of claim 1, wherein the expansion circuit comprises one of: a biometric detector and a medical diagnostic device.

12. The circuit of claim 1, wherein the expansion circuit comprises a bar code reader.

13. The circuit of claim 1, wherein the expansion circuit comprises one of: a radio frequency identification (RFID) unit and a garage door opener.

14. The circuit of claim 1, wherein the expansion circuit comprises a wireless credit card.

15. The circuit of claim 1, wherein the expansion circuit comprises a credit card number upon query.

16. The circuit of claim 1, wherein the expansion circuit comprises one of: a reserve energy supply, a super-capacitor, a solar cell, a fuel cell, and a battery.

17. The circuit of claim 1, comprising a data storage device mounted on the expansion board.

18. The circuit of claim 1, wherein the expansion circuit comprises a PC compatible processor with Windows OS, Linux OS, or Macintosh OS X.

19. A cellular telephone comprising:
a processor;
a display;
an expansion connector;
an expansion circuit plugged into the expansion connector of the telephone, wherein the circuit comprises at least one of: an 802.11 transceiver, a Zigbee transceiver, a global positioning system receiver, a compass, a data storage device to store map data and to display the output of the expansion circuit with the map data, an altimeter, a barometer, a chronograph, a thermometer, a medical diagnostic unit, a television receiver, a radio receiver, a graphics accelerator, a connector to receive a game cartridge, a biometric detector, a bar code reader, a radio frequency identification (RFID) unit, a wireless credit card, a reserve energy supply, a super-capacitor, a solar cell, a fuel cell, a battery, and a PC compatible processor running Windows OS, Linux OS, or Macintosh OSX.

20. The cellular telephone of claim 19, wherein the display conforms to a 16 by 9 aspect ratio.

21. The cellular telephone of claim 19, wherein the expansion circuit comprises one of a Secure Digital (SD) card, a SmartMedia (SM) card, a Multimedia card (MMC), a CompactFlash (CF) card, a PC card, a Memory Stick and an xD Picture card.

22. The cellular telephone of claim 19, comprising a telescoping radio frequency antenna extendable from the expansion circuit.

23. A method to expand cellular telephone functionality, comprising:
inserting a secure digital card with an expansion circuit into the cellular telephone, wherein the expansion circuit comprises at least one of: an 802.11 transceiver, a Zigbee transceiver, a global positioning system receiver, a compass, a data storage device to store map data and to display the output of the expansion circuit with the map data, an altimeter, a barometer, a chronograph, a thermometer, a medical diagnostic unit, a television receiver, a radio receiver, a graphics accelerator, a connector to receive a game cartridge, a biometric detector, a bar code reader, a radio frequency identification (RFID) unit, a wireless credit card, a reserve energy supply, a super-capacitor, a solar cell, a fuel cell, a battery, and a PC compatible processor running Windows OS, Linux OS, or Macintosh OS X; and executing computer code executed by the cellular telephone to retrieve information from the expansion circuit and communicating the information to a user.
